(19) United States
(12) Patent Application Publication
(10) Pub. No.: US 2020/0272980 A1
(43) Pub. Date: Aug. 27, 2020

(54) System for Managing Garments

(71) Applicant: Ebony Bandy, Humble, TX (US)

(72) Inventor: Ebony Bandy, Humble, TX (US)

(21) Appl. No.: 16/590,124

(22) Filed: Oct. 1, 2019

Related U.S. Application Data
(60) Provisional application No. 62/810,846, filed on Feb. 26, 2019.

(51) Int. Cl. G06Q 10/08; A47B 61/00; G07C 9/00; G06K 7/10

(52) U.S. Cl. CPC G06Q 10/087; A47B 61/00; G06K 7/10792; G06K 7/10881; G07C 9/00158

(57) ABSTRACT

A system of managing garments allows garments to be digitally tracked whenever deposited into or withdrawn from the system. The system of managing garments includes a kiosk housing, a plurality of storage containers, a controller, at least one output device, and a plurality of scannable garment tags. The kiosk housing is a self-service structure that encases the plurality of storage containers. The plurality of storage containers is primarily used for the storage of garments. The controller is used to manage the electronic functions of the system. The at least one output device is used to output garment deposit and withdrawal information. The plurality of scannable garment tags may be attached onto a garment in order to digitally track said garment. Moreover, each of the plurality of storage containers includes a first scanning device. The first scanning device is used to digitally track a garment with an attached scannable tag.

The current application claims a priority to the U.S. Provisional Patent application Ser. No. 62/810,846 filed on Feb. 26, 2019.

### FIELD OF THE INVENTION

The present invention relates generally to a remotely operated or fully autonomous locker or other similar container suitable for storing and dispensing garments. Additionally, a control apparatus is contemplated in association to the means of storage such that the garments may be digitally tracked or otherwise accounted for during withdrawal or deposit from the present invention.

### BACKGROUND OF THE INVENTION

In present times, individuals are known to store work- or task-specific garments in designated storage containers or enable ready access to critical equipment. Generally, these containers are adjacent to other containers belonging to coworkers or colleagues or containing other types of equipment. It is also known that equipment dedicated to specific tasks, particularly protecting equipment, must be routinely cleaned, repaired, or inspected to ensure the proper function of said equipment. This is especially true for personal protective equipment (PPE), where the failure of a critical component puts an individual user or group of users at risk of injury. Even in less hazardous pursuits, uniforms must be routinely laundered to ensure proper hygiene and maintain appearances in a workplace. An employer will commonly contract with outside services to recondition or launder the equipment or garments utilized by employees, requiring the collection and dispersion of the garments. It is understood that each garment may be fit to only one particular employee, and that the validation of the pickup and return of the garments must be verified to ensure that the contracted services that were paid for were performed. This is further complicated by a potential lack of unique identifiers associated with each garment, which is an issue inherent to the use of a uniform. This combinations of needs and shortcomings has created a demand for a digitized proof-of-work and inventory management system that may be applied to individual equipment, without requiring the centralized collection of said equipment.

The present invention aims to offer a means of storing, tracking, and recording the possession of any known form of equipment, ideally wearable garments, and clothing. The present invention will accomplish this via a series of modular storage containers equipped with the means to recognize and record the deposit or withdrawal of specific items from said containers, including the identity of the individual taking possession of a particular piece of equipment. Pursuant to this function, the present invention offers a system of digitally identifying any type of garment via the application of a multi-functional identifier, utilized to automatically track the use of said garment. In at least one mode of contemplated use, the present invention will track the use of garments that are equipped with such identifiers without and direct input from a user.

### BRIEF DESCRIPTION OF THE DRAWINGS

FIG. 1 is a front perspective view of the present invention.

FIG. 2 is a front schematic view of the present invention displaying the electronic connections.

FIG. 3 is a rear perspective view of the present invention.

FIG. 4 is a front schematic view of the present invention displaying the electronic connections of the second scanning device, the third scanning device, and the biometric scanning device.

FIG. 5 is a front schematic view of the present invention displaying the electronic connections of the display screen and the control interface.

FIG. 6 is a front schematic view of the present invention displaying the printer.

### DETAIL DESCRIPTIONS OF THE INVENTION

All illustrations of the drawings are for the purpose of describing selected versions of the present invention and are not intended to limit the scope of the present invention.

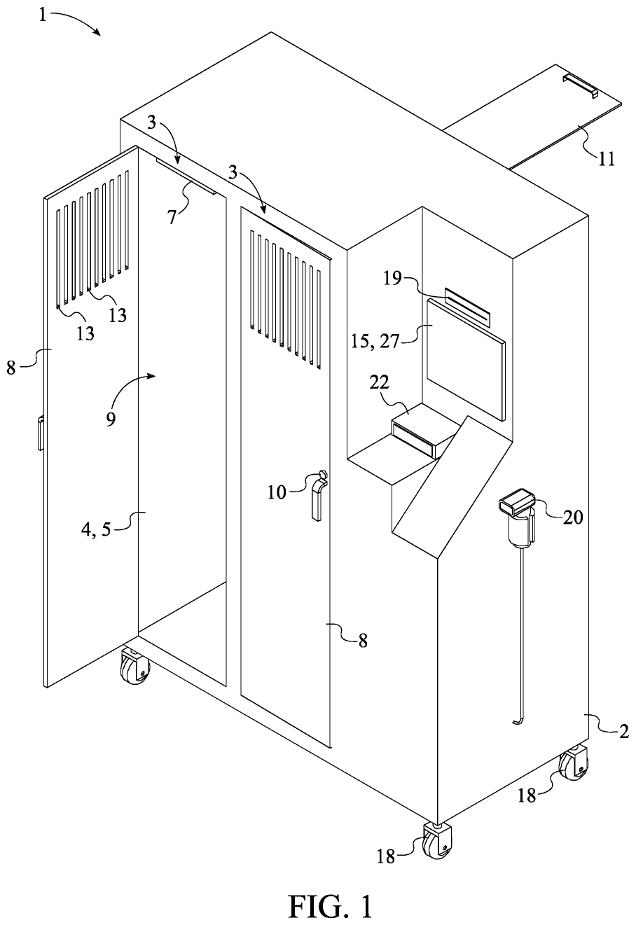

In reference to FIGS. 1 through 5, the present invention is a system of managing garments that allows garments to be digitally tracked whenever deposited into or withdrawn from the present invention. The present invention comprises a kiosk housing 1, a plurality of storage containers 3, a controller 14, at least one output device 15, and a plurality of scannable garment tags 16. The kiosk housing 1 is a self-service structure that encases the plurality of storage containers 3. The plurality of storage containers 3 is primarily used for the storage of garments. The controller 14 is a self-contained computer chip that includes electronic components such as, but not limited to, a processor, and memory storage. Further, the controller 14 is used for the electronic management and command functions of the present invention. The at least one output device 15 is used to output information such as, but not limited to, garment deposit and withdrawal information of the present invention. The plurality of scannable garment tags 16 may be attached onto a garment in order to digitally track said garment. Moreover, each of the plurality of storage containers 3 comprises a first scanning device 7. The first scanning device 7 is used to digitally track when a garment, with a scannable garment tag, is deposited into or withdrawn from a storage container of the plurality of storage containers 3. The first scanning device 7 may be any type of digital reading device such as, but not limited to, a barcode scanning device, a quick-response (QR) scanning device, or a radio frequency identifier (RFID) scanning device. Moreover, the plurality of scannable garment tags 16 must be compatible with the first scanning device 7.

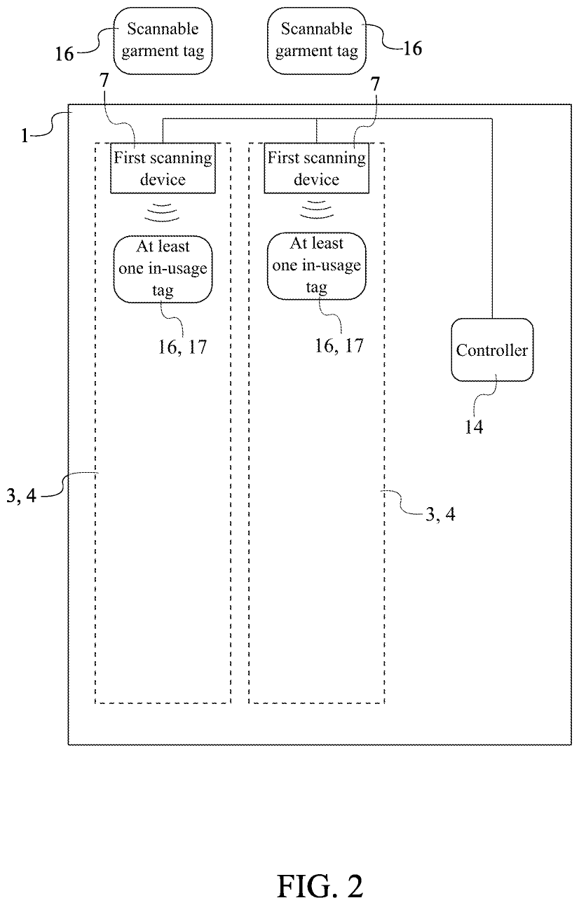

The general configuration of the aforementioned components allows the present invention to digitally track whenever a garment is deposited into or withdrawn from the present invention. With reference to FIGS. 1 and 2, each of the plurality of storage containers 3 further comprises a container body 4. The container body 4 is preferably a storage structure such as, but not limited to, a locker. The plurality of storage containers 3 is integrated into the kiosk housing 1. This arrangement establishes a secure connection between the plurality of storage containers 3 and the kiosk housing 1 which further prevents the plurality of storage containers 3 from being removed from the kiosk housing 1. The controller 14 is mounted within the kiosk housing 1 in order for the controller 14 to be concealed and protected by the kiosk housing 1. The first scanning device 7 is mounted within the container body 4 in order to be protected and concealed by the container body 4. Further, this arrangement positions the first scanning device 7 to effectively and digitally track garments whenever the garments, with a scannable garment tag attached, are being deposited into or withdrawn from a storage container of the plurality of storage containers 3. At least one in-usage tag 17 from the plurality of scannable garment tags 16 is positioned within the container body 4 of a specific container from the plurality of storage containers 3. The at least one in-usage tag 17 is a scannable garment tag that is attached onto a garment. Further, the at least one in-usage tag 17 is communicably coupled to the first scanning device 7 of the specific container. This arrangement allows the garment, on which the at least one in-usage tag 17 is attached, to be digitally tracked by the first scanning device 7. Moreover, the first scanning device 7 of each of the plurality of storage containers 3 and the at least one output device 15 are electronically connected to the controller 14. This allows the controller 14 to manage and communicate with the first scanning device 7 of each of the plurality of storage containers 3 and the at least one output device 15.

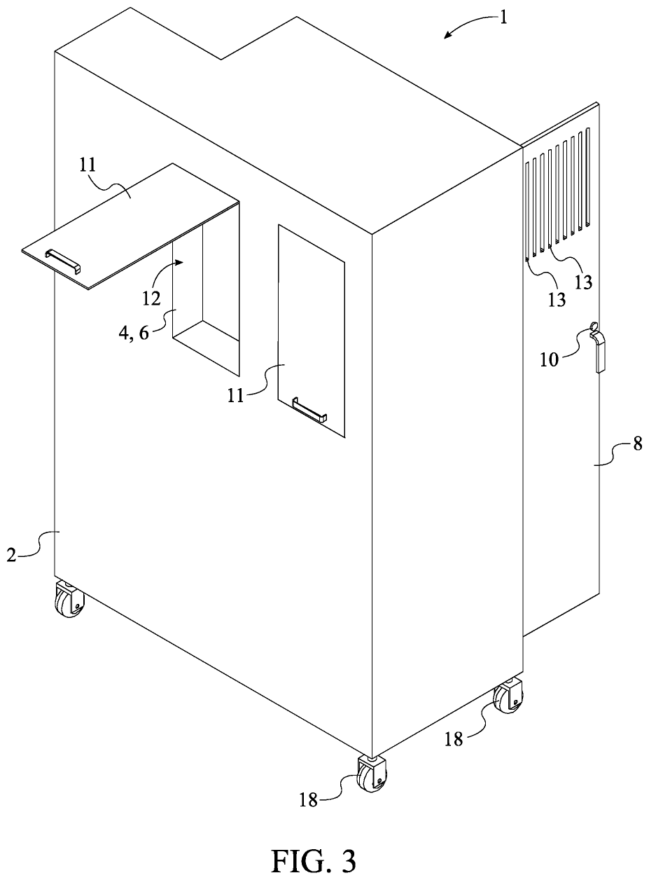

With reference to FIGS. 1 and 3, the present invention may further comprise a plurality of casters 18. The plurality of casters 18 allows a user to easily transport the present invention. Further, the kiosk housing 1 comprises a housing base 2. The plurality of casters 18 is rotatably mounted to the housing base 2. This arrangement allows the kiosk housing 1 to be rolled across a ground surface by the plurality of casters 18. Moreover, the plurality of casters 18 is distributed across the housing base 2. This arrangement allows the plurality of casters 18 to support the weight of the kiosk housing 1.

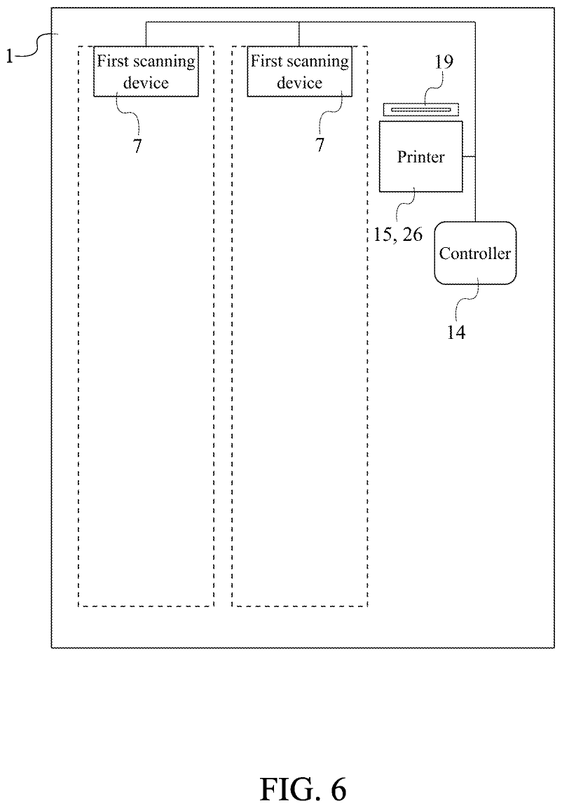

With reference to FIGS. 1 and 6, the present invention may further comprise a paper outlet 19. The paper outlet 19 allows paper or similar material to be outputted out of the kiosk housing 1. In one embodiment of the present invention, the at least one output device 15 comprises a printer 26. The printer 26 may be any device able to inscribe the deposit/withdrawal results on paper or other similar material. The printer 26 is mounted within the kiosk housing 1 in order to be conceal and protected by the kiosk housing 1. Further, the paper outlet 19 laterally traverses into the kiosk housing 1 and is positioned adjacent to the printer 26. This arrangement allows paper or other similar material to be outputted from the printer 26 and out of the kiosk housing 1.

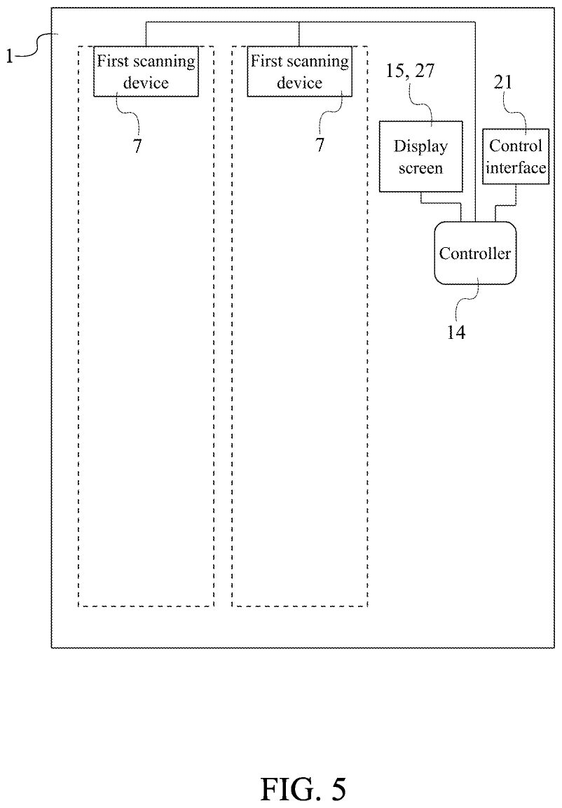

In another embodiment of the present invention and with reference to FIGS. 1 and 5, the at least one output device 15 comprises a display screen 27. The display screen 27 may any type of display such as, but not limited to, a touch-screen display, or an LED display that can output the deposit/withdrawal results. The display screen 27 is externally mounted to the kiosk housing 1. This arrangement positions the display screen 27 in order to be easily viewed by a user.

With reference to FIG. 1, each of the plurality of storage containers 3 further comprises a door 8, a first access opening 9, and a locking mechanism 10. The door 8 is used to conceal or reveal the first access opening 9. The first access opening 9 allows a user to access any garments placed inside of a storage container from the plurality of storage containers 3. The locking mechanism 10 is used to provide a security feature to each of the plurality of storage containers 3. The locking mechanism 10 can be any type of locking mechanism 10 such as, but not limited, a key padlock, code padlock, or an electronic lock. The container body 4 comprises a front portion 5. The first access opening 9 laterally traverses into the front portion 5 in order to allow access to the garments inside the container body 4. The door 8 is hingedly mounted to the front portion 5, adjacent to the first access opening 9 in order to conceal or reveal the first access opening 9. The door 8 is operatively coupled to the front portion 5 by the locking mechanism 10. The locking mechanism 10 is used to lock or unlock the door 8. Thus, the locking mechanism 10 provides security to each of the plurality of storage containers 3.

With reference to FIG. 3, each of the plurality of storage containers 3 further comprises a hatch 11 and a second access opening 12. The hatch 11 is used to conceal or reveal the second access opening 12. The second access opening 12 is used to allow a secondary user to withdraw the garments when laundering is required. In further detail, the second access opening 12 is intended to allow a laundry worker to access the garments. The container body 4 comprises a rear portion 6. The second access opening 12 laterally traverses into the rear portion 6 in order to allow a user to withdraw the garments from the backside of the kiosk housing 1. The hatch 11 is hingedly mounted to the rear portion 6, adjacent to the second access opening 12 in order to conceal or reveal the second access opening 12.

With reference to FIG. 1, each of the plurality of storage containers 3 further comprises a plurality of vents 13. The plurality of vents 13 is used to prevent bad odor of the garments from accumulating inside each of the plurality of storage containers 3. In further detail, the air is free to flow inside or out of each of the plurality of storage containers 3. The plurality of vents 13 traverses into the front portion 5. Thus, bad odor can dispense out of each of the plurality of storage containers 3.

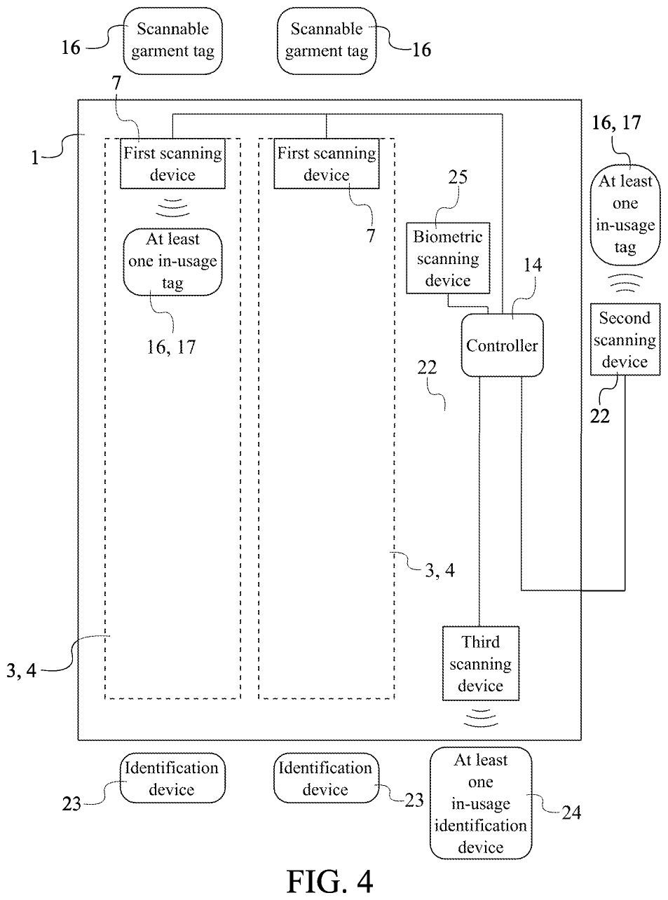

With reference to FIGS. 1 and 4, the present invention may further comprise a second scanning device 20. The second scanning device 20 allows a user to manually and digitally track whenever a garment is deposited into or withdrawn from the present invention. In further detail, the second scanning device 20 is manually operated by a user while the first scanning device 7 does not require a user to function. The second scanning device 20 is preferably the same type of digital reading device as the first scanning device 7. The second scanning device 20 is tethered to the kiosk housing 1. This arrangement allows a user to easily maneuver the second scanning device 20 and prevents the second scanning device 20 from being removed from the kiosk housing 1. Moreover, the second scanning device 20 is electronically connected to the controller 14 in order for the controller 14 to manage and communicate with the second scanning device 20. Further, the at least one in-usage tag 17 is communicably coupled to the second scanning device 20. This allows the second scanning device 20 to digitally track the at least one in-usage tag 17.

With reference to FIG. 5, the present invention may further comprise a control interface 21. The control interface 21 allows a user to input instructions such as, but not limited to, outputting deposit/withdrawal information or opening/closing a storage container from the plurality of storage containers 3. The control interface 21 is externally mounted to the kiosk housing 1. This arrangement allows a user to easily access the control interface 21. The control interface 21 is electronically connected to the controller 14 in order for the controller 14 to manage and communicate with the control interface 21. The control interface 21 may be integrated into the at least one output device 15. In further detail, the control interface 21 may be a touch-screen display.

With reference to FIGS. 1 and 4, the present invention may further comprise a third scanning device 22 and a plurality of identification devices 23. The third scanning device 22 is used to allow access to the present invention. In further detail, the third scanning device 22 is used to authorize access to a specific container from the plurality of containers. Further, the third scanning device 22 may be any type of digital reading device such as, but not limited to, a RFID scanning device or a card scanning device. The plurality of identification devices 23 is used to request access to the present invention. The plurality of identification devices 23 must be compatible with the third scanning device 23. In further detail, the third scanning device 22 is used to allow access to a specific storage container from the plurality of storage containers 3. Moreover, each of the plurality of identification devices 23 is used to request access to a specific storage container from the plurality of storage containers 3. Alternately or additionally, the third scanning device 22 is used to allow access to output deposit/withdrawal information. Moreover, at least one identification device from the plurality of identification devices 23 may be for an administrator account to request access to output deposit/withdrawal information. The third scanning device 22 is externally mounted to the kiosk housing 1. This arrangement allows the third scanning device 22 to be easily interacted by a user. The third scanning device 22 is electronically connected to the controller 14 in order for the controller 14 to manage and communicate with the third scanning device 22. Further, the at least one in-usage identification device 24 from the plurality of identification devices 23 is communicably coupled to the third scanning device 22 in order for the third scanning device 22 to process an access request by the at least one in-usage identification device 24.

With reference to FIG. 4, the present invention may further comprise a biometric scanning device 25. The biometric scanning device 25 may be any type of biometric reader such as, but not limited to, a fingerprint reader, a facial recognition scanner, or a voice recognition device. The biometric scanning device 25 is used to allow access to a specific storage container from the plurality of storage containers 3. In further detail, a user is able to access his or her specific storage container by using the biometric scanning device 25. The biometric scanning device 25 is externally mounted to the kiosk housing 1 in order to be easily interacted by a user. Further, the biometric scanning device 25 is electronically connected to the controller 14 so that the controller 14 is able to receive a biometric reading from the biometric scanning device 25.

Although the invention has been explained in relation to its preferred embodiment, it is to be understood that many other possible modifications and variations can be made without departing from the spirit and scope of the invention as hereinafter claimed.

What is claimed is:

1. A system of managing garments comprises:
a kiosk housing;
a plurality of storage containers;
a controller;
at least one output device;
a plurality of scannable garment tags;
each of the plurality of storage containers comprises a container body and a first scanning device;
the plurality of storage containers being integrated into the kiosk housing;
the controller being mounted within the kiosk housing;
the first scanning device being mounted within the container body;
at least one in-usage tag from the plurality of scannable garment tags being positioned within the container body of a specific container from the plurality of storage containers;
the at least one in-usage tag being communicably coupled to the first scanning device of the specific container; and
the first scanning device of each of the plurality of storage containers and the at least one output device being electronically connected to the controller.

2. The system of managing garments as claimed in claim 1 comprises:
a plurality of casters;
the kiosk housing comprises a housing base;
the plurality of casters being rotatably mounted to the housing base; and
the plurality of casters being distributed across the housing base.

3. The system of managing garments as claimed in claim 1 comprises:
a paper outlet;
the at least one output device comprises a printer;
the printer being mounted within the kiosk housing;
the paper outlet laterally traversing into the kiosk housing; and
the paper outlet being positioned adjacent to the printer.

4. The system of managing garments as claimed in claim 1 comprises:
the at least one output device comprises a display screen;
the display screen being externally mounted to the kiosk housing; and
the display screen being electronically connected to the controller.

5. The system of managing garments as claimed in claim 1 comprises:
each of the plurality of storage containers further comprises a door, a first access opening, and a locking mechanism;
the container body comprises a front portion;
the first access opening laterally traversing into the front portion;
the door being hingedly mounted to the front portion, adjacent to the first access opening; and
the door being operatively coupled to the front portion by the locking mechanism, wherein the locking mechanism is used to lock or unlock the door.

6. The system of managing garments as claimed in claim 1 comprises:
each of the plurality of storage containers further comprises a hatch and a second access opening;
the container body comprises a rear portion;
the second access opening laterally traversing into the rear portion; and
the hatch being hingedly mounted to the rear portion, adjacent to the second access opening.

7. The system of managing garments as claimed in claim 1 comprises:
each of the plurality of storage containers further comprises a plurality of vents;
the container body comprises a front portion; and
the plurality of vents traversing into the front portion.

8. The system of managing garments as claimed in claim 1 comprises:
a second scanning device;
the second scanning device being tethered to the kiosk housing;
the second scanning device being electronically connected to the controller; and
the at least one in-usage tag being communicably coupled to the second scanning device.

9. The system of managing garments as claimed in claim 1 comprises:
a control interface;
the control interface being externally mounted to the kiosk housing; and
the control interface being electronically connected to the controller.

10. The system of managing garments as claimed in claim 1 comprises:
a third scanning device;
a plurality of identification devices;
the third scanning device being externally mounted to the kiosk housing;
the third scanning device being electronically connected to the controller; and
at least one in-usage identification device from the plurality of identification devices being communicably coupled to the third scanning device.

11. The system of managing garments as claimed in claim 1 comprises:
a biometric scanning device;
the biometric scanning device being externally mounted to the kiosk housing; and
the biometric scanning device being electronically connected to the controller.

12. A system of managing garments comprises:
a kiosk housing;
a plurality of storage containers;
a controller;
at least one output device;
a plurality of scannable garment tags;
a second scanning device;
a control interface;
each of the plurality of storage containers comprises a container body and a first scanning device;
the plurality of storage containers being integrated into the kiosk housing;
the controller being mounted within the kiosk housing;
the first scanning device being mounted within the container body;
at least one in-usage tag from the plurality of scannable garment tags being positioned within the container body of a specific container from the plurality of storage containers;
the at least one in-usage tag being communicably coupled to the first scanning device of the specific container;
the first scanning device of each of the plurality of storage containers and the at least one output device being electronically connected to the controller;
the second scanning device being tethered to the kiosk housing;
the second scanning device being electronically connected to the controller;
the at least one in-usage tag being communicably coupled to the second scanning device;
the control interface being externally mounted to the kiosk housing; and
the control interface being electronically connected to the controller.

13. The system of managing garments as claimed in claim 12 comprises:
a plurality of casters;
the kiosk housing comprises a housing base;
the plurality of casters being rotatably mounted to the housing base; and
the plurality of casters being distributed across the housing base.

14. The system of managing garments as claimed in claim 12 comprises:
a paper outlet;
the at least one output device comprises a printer;
the printer being mounted within the kiosk housing;
the paper outlet laterally traversing into the kiosk housing; and
the paper outlet being positioned adjacent to the printer.

15. The system of managing garments as claimed in claim 12 comprises:
the at least one output device comprises a display screen;
the display screen being externally mounted to the kiosk housing; and
the display screen being electronically connected to the controller.

16. The system of managing garments as claimed in claim 12 comprises:
each of the plurality of storage containers further comprises a door, a first access opening, a locking mechanism, a hatch, a second access opening, and a plurality of vents;
the container body comprises a front portion and a rear portion;
the first access opening laterally traversing into the front portion;
the door being hingedly mounted to the front portion, adjacent to the first access opening;
the door being operatively coupled to the front portion by the locking mechanism, wherein the locking mechanism is used to lock or unlock the door;
the second access opening laterally traversing into the rear portion;
the hatch being hingedly mounted to the rear portion, adjacent to the second access opening; and
the plurality of vents traversing into the front portion.

17. The system of managing garments as claimed in claim 12 comprises:
a third scanning device;
a plurality of identification devices;
the third scanning device being externally mounted to the kiosk housing;
the third scanning device being electronically connected to the controller; and
at least one in-usage identification device from the plurality of identification devices being communicably coupled to the third scanning device.

18. The system of managing garments as claimed in claim 12 comprises:
a biometric scanning device;
the biometric scanning device being externally mounted to the kiosk housing; and
the biometric scanning device being electronically connected to the controller.
